(19) United States
(12) Patent Application Publication
(10) Pub. No.: US 2025/0028715 A1
(43) Pub. Date: Jan. 23, 2025

(54) DATA STANDARDIZATION USING MACHINE LEARNING FOR COMPREHENSIVE QUERY PROCESSING

(71) Applicant: UKG Inc., Weston, FL (US)

(72) Inventors: Viraj Thakur, Westford, MA (US); Brett Philip Myers, Noblesville, IN (US); Alexander Khvesko, Warsaw (PL); Yaraslau Byshyk, Vilnius (LT)

(21) Appl. No.: 18/222,592

(22) Filed: Jul. 17, 2023

(51) Int. Cl. G06F 16/2452; G06F 16/242; G06F 40/30

(52) U.S. Cl. CPC G06F 16/24528; G06F 16/243; G06F 40/30

(57) ABSTRACT

Techniques and systems for data standardization using machine learning are provided. The techniques include identifying a query that includes a data unit, representing the data unit via token(s), processing the token(s) using a plurality of machine learning models (MLMs) to identify cluster(s) associated with at least one token of the data unit. Processing may include using a first MLM to evaluate statistical associations of the token(s) with cluster(s). Processing may further include using a second MLM to evaluate lexical associations of the token(s) with the cluster(s). The techniques may further include retrieving, using the one or more identified clusters, data associated with the query.

### TECHNICAL FIELD

Embodiments of the present disclosure relate to computing systems, and more specifically, to methods and systems for data standardization and comprehensive processing of queries.

### BACKGROUND

Businesses, especially small-size businesses and medium-size businesses, and non-profit organizations often do not have sufficient computing resources and human personnel to develop comprehensive support services (e.g., software support, policies and procedures, tracking and reporting systems, etc.) fully in-house and have to rely on specialized outside developers and providers of these services. Such providers may furnish, to client businesses and organizations, various hardware and software computing resources (e.g., cloud-based and/or local) as well as subject-matter expertise that reduce administrative overhead and automate a significant number of support tasks, such as maintaining inventory, tracking deliveries and shipments, complying with rules and regulations, implementing data security and personnel/environment safety measures, managing human resources, and/or the like. Human resource management may include maintaining job descriptions, managing employee salaries and benefits, tracking job-related activities and relations of employees, supporting employee recruiting, monitoring employee satisfaction, keeping abreast of changes in the relevant industries and geographic areas, and/or the like.

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates a high-level component diagram of an example architecture, in accordance with one or more embodiments of the present disclosure.

FIG. 2 illustrates an example workflow of training a statistical model that may be used for database standardization, in accordance with one or more embodiments of the present disclosure.

FIG. 3 illustrates an example workflow of deploying machine learning for database standardization, in accordance with one or more embodiments of the present disclosure.

FIG. 4 is a flow diagram illustrating an example method of deploying machine learning for data standardization, in accordance with one or more embodiments of the present disclosure.

FIG. 5 is a flow diagram illustrating an example method of training one or more models that may be used for database standardization, in accordance with one or more embodiments of the present disclosure.

FIG. 6 is a block diagram illustrating a computing system in which implementations of the disclosure can be used.

### DETAILED DESCRIPTION

Efficient provisioning of support services depends on the ability of a provider of such services to process information related to multiple clients (e.g., businesses) efficiently and comprehensively. Such information is often fragmented by industry, geography, state of client's operations, and so on. For example, even clients operating in the same industry and/or state may use very different terminology to refer to the same jobs, entities, operations, and procedures. For example, the same or similar jobs may be designated as “manager,” “supervisor,” “senior staff member,” “dispatcher,” “shift coordinator,” and/or the like. Work beyond regular business hours may be referred to as “overtime,” “double time,” “extra time,” and/or the like. Such data fragmentation may hinder the provider's ability to serve various clients. In particular, a client may be interested in learning about best business practices of human resource management, salary and benefits ranges of various jobs, on-site safety, and/or the like, but a search query that does not capture nuances and varieties of terminology being used may cause the provider to miss a significant slice of data, even if the data is available in the provider's data stores. Searching for and manually indexing various terms is a very expensive, slow, and inefficient process given large volumes of available information and the fact that such information may be constantly changing/updating as a result of new terminology being introduced, new clients served, and/or the like.

Aspects and implementations of the instant disclosure address the above-mentioned and other challenges of the existing technology by providing for systems and techniques capable of using machine learning for automated data standardization and efficient data query processing. In some embodiments, data entities collected from a variety of sources (e.g., clients, public sources, and/or the like) may be tokenized (split into segments having distinct semantic meanings), represented in the form of digital embeddings, and processed by one or more machine learning models (MLMs) to perform clustering of various units of data among clusters associated with specific semantic meanings. Clustering may be facilitated by associating anchor tokens (also referred to as, simply, anchors herein) with various clusters. Anchors represent some of the (actual or expected) data entities (units) having semantic values that are similar to the cluster's semantic value(s). In some embodiments, the MLMs that perform clustering may include a statistical model (SM) generating probabilities that a particular token is associated with various clusters. The SM can be trained using anchors. For example, individual clusters may be initiated (seeded) with one or more anchors. Various data units may then be processed by the SM and individual tokens in the data units may acquire, for each cluster, a score (weight) that is determined by a frequency with which the token is encountered in data units in combination with anchors of that cluster. The SM may be used together with one or more additional models. In some embodiments, a lexical model (LM), e.g., a model that deploys techniques of natural language processing model, may be used. The LM may be initially pre-trained using a general vocabulary and natural language training techniques. Subsequently, the LM may be further trained using data units labeled by the trained SM as ground truth. During classification of a new data unit, the data unit may be tokenized, digitized and processed by the SM and/or the LM, e.g., in parallel. Each of the models may generate separate predictions, e.g., probabilities, that the data unit or its individual tokens belong to specific clusters. The probabilities generated by individual models may be aggregated (e.g., averaged or otherwise weighted) and a cluster identified with a maximum probability may indicate a semantic value of the data unit (or its individual tokens). As a result, data units that include seemingly distinct but semantically close meanings (e.g., job titles, job descriptions, etc.) are associated with the same cluster. This facilitates that various database queries (e.g., searches and/or requests for specific categories of data) return comprehensive results that include multiple relevant items of information even when such items are expressed via different words (which in fact have the same or similar meanings).

The advantages of the disclosed techniques include but are not limited to quick and comprehensive queries for data, documents, content, structured and unstructured information that is available in digitized data stores. Correspondingly, efficient identification and retrieval of relevant information facilitates supplying clients with complete information for informed actions by the clients. The disclosed techniques may be used in workforce management (WFM) and human capital management (HCM) application and, in particular, including standardization of WFM/HCM for small and medium business entities, efficient identification and retrieval of jobs data, paycodes/counter data, transferring WFM/HCM practices developed by some organizations to other organizations in the same industry or to other industries, and/or the like. Furthermore, the disclosed techniques may be used for efficient cross-tenant management of tenants that use different business practices, terminology, data management techniques, and/or the like.

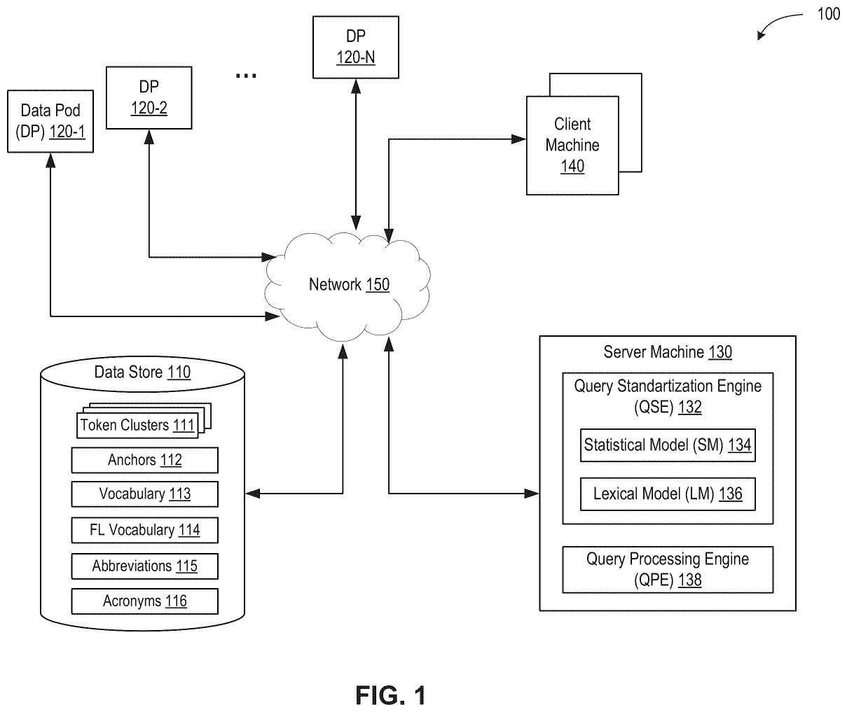

FIG. 1 illustrates a high-level component diagram of an example system architecture 100, in accordance with one or more aspects of the present disclosure. The system architecture 100 (also referred to as “system” herein) includes a data store 110, one or more data pods (DPs) 120-1, 120-2 . . . 120-N, a server machine 130, one or more client machines 140, and/or other components connected to a network 150. In some embodiments, network 150 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), and/or the like. In some embodiments, network 150 may include routers, hubs, switches, server computers, and/or a combination thereof.

In some embodiments, DPs 120-j may store any suitable raw and/or processed data units that may be collected from any number of clients, e.g., businesses, public and private foundations, government agencies, non-profit organizations, institutions, associations, charities, partnerships, and/or the like. Different DPs 120-j may be serving (e.g., collecting information from) different geographic areas, states, industries, businesses of different types and sizes, and/or the like. In some embodiments, DPs 120-j may store information that includes job titles, job descriptions, salaries, benefits, employment policies, laws and government regulations, listing of services provided by clients to customers, inventories of goods, and/or any other suitable public and/or private data. DPs 120-j may store information together with various structures that tag, organize, and index the data. Data store 110 may store various data and metadata used and/or generated to facilitate processing of information collected in DPs 120-j. In some embodiments, data store 110 may store token clusters 111 (also referred to as simply clusters throughout this disclosure) that group various data units collected in DPs 120-j by semantic meaning. Each token cluster 111 may correspond to a specific semantic entity, e.g., “overtime pay,” but may be expressed using different words a multitude of different ways. Token clusters 111 may include references (e.g., pointers) to specific data units stored in one or more DPs 120-j that have been previously identified as belonging to various clusters. Token clusters 111 may be defined using anchors 112 (also referred to as anchor tokens herein). Anchors 112 may be example tokens that are commonly encountered (or expected to be encountered) in data units associated with semantic meaning of the respective clusters 111. In some embodiments, anchors 112 may be initially identified by system developers. Data store 110 may store a vocabulary 113, e.g., a corpus of words in a principal language used by at least some of the clients. Data store 110 may also store one or more foreign language (FL) vocabularies 114 with translations of at least some words of vocabulary 113. Data store 110 may also store a list of abbreviations 115 in the principal language and/or foreign language(s) and a list of acronyms 116 in the principal language and/or foreign language(s).

Any or some of data store 110 and/or DPs 120-j may be implemented in a persistent storage capable of storing files as well as data structures to perform identification of data, in accordance with implementations of the present disclosure. Data store 110 and/or DPs 120-j may be hosted by one or more storage devices, such as main memory, magnetic or optical storage disks, tapes, or hard drives, network-attached storage (NAS), storage area network (SAN), and so forth. Although depicted as separate from the server machine 130, data store 110 and/or DPs 120-j may be part of server machine 130, and/or other devices. In some embodiments, data store 110 and/or DPs 120-j may be implemented on a network-attached file server, while in other implementations data store 110 and/or DPs 120-j may be implemented on some other types of persistent storage, such as an object-oriented database, a relational database, and so forth, that may be hosted by a server machine 130 or one or more different machines coupled to server machine 130 via network 150.

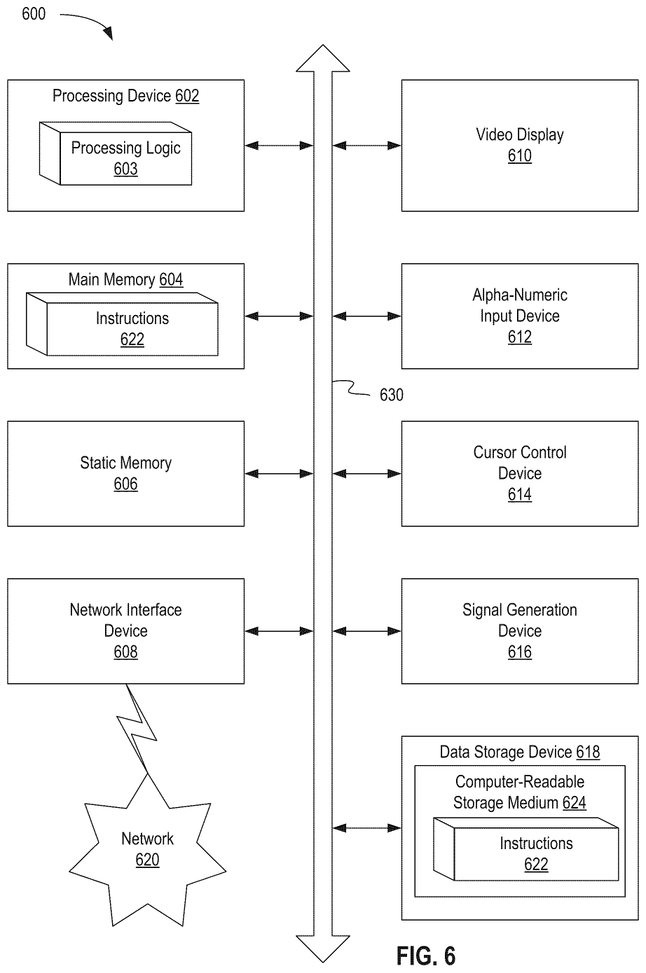

In some embodiments, any of server machine 130 and/or client machine(s) 140 may include a desktop computer, a laptop computer, a smartphone, a tablet computer, a server, a scanner, or any suitable computing device capable of performing the techniques described herein. In some implementations, any of server machine 130 and/or client machine(s) 140 may be (and/or include) one or more computer systems 600 of FIG. 6. Server machine 130 may include a query standardization engine (QSE) 132 trained to identify and group data units having different lexical form but the same and/or similar semantic meaning, as disclosed herein. QSE 132 may include SM 134 trained to identify associations of tokens in data units with anchors 112 of various clusters 111 based on statistics of co-appearance of respective tokens and anchors 112 in data units. QSE 132 may further include LM 136 trained to identify associations of tokens with various clusters 111 using natural language processing techniques. Server 130 may further include a query processing engine (QPE) 138 to facilitate retrieval of data during processing of new search queries. For example, a client may submit, via one of client machines 140, a request for information, e.g., a request to find statistics about salary and benefits of nurse practitioners in a particular geographic area. QSE 132 may process tokens in the client request and identify most likely associations of the tokens with one or more clusters 111, thus determining semantic meanings of the tokens. QPE 138 may then retrieve stored information related to the determined semantic meanings, e.g., to multiple forms in which the same or substantially the same semantic meanings are expressed in different words. Upon retrieving stored information, QPE 138 may eliminate false hits, combine positive hits, generate relevant statistics, compile a report, and/or perform any other operations that may be expected by the client.

QSE 132 and/or QPE 138 may include (or may have access to) instructions stored on one or more tangible, machine-readable storage media of server machine 130 and executable by one or more processing devices of server machine 130. In one implementation, QSE 132 and/or QPE 138 may be implemented as a single component. In some implementations, QSE 132 and/or QPE 138 may each be a client-based application or may be a combination of a client component and a server component. In some implementations, QSE 132 and/or QPE 138 may be executed entirely on the client machine(s) 140. Alternatively, some portion of QSE 132 and/or QPE 138 may be executed on a client computing device while another portion of QSE 132 and/or QPE 138 may be executed on a server machine 130.

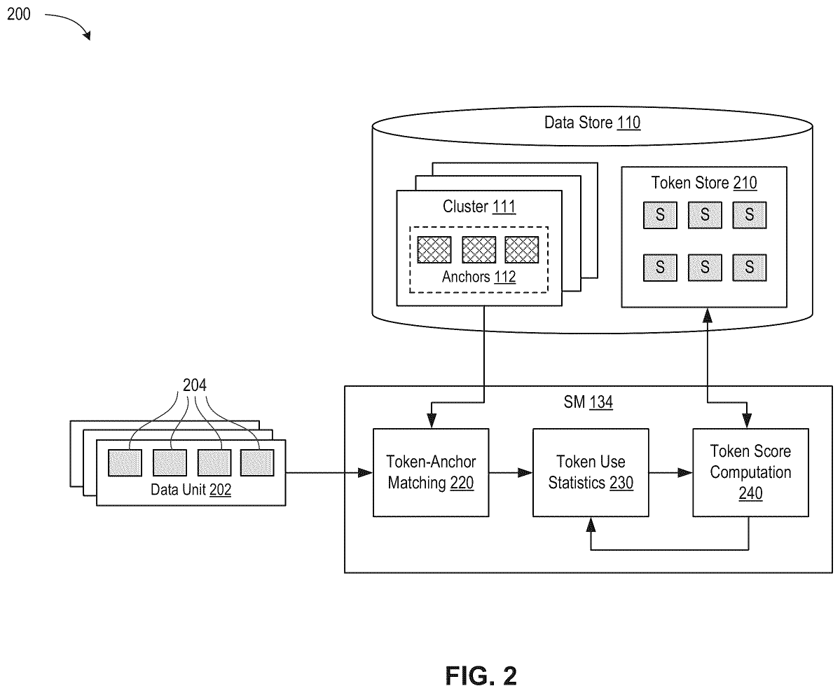

FIG. 2 illustrates an example workflow 200 of training a statistical model that may be used for database standardization, in accordance with one or more embodiments of the present disclosure. SM 134 may be trained using multiple data units 202, which may include any information collected in one or more DPs 130-j, stored in data store 110, and/or other suitable data stores. Data units 202 may include structured or unstructured data, historical data queries (e.g., data queries generated by any of the clients), and/or other types of information. Each data unit 202 may be tokenized, e.g., segmented into one or more tokens 204. A token 204 may include any character, a combination of characters, a word, a combination of words, an abbreviated word, an acronym, etc., that have a recognized semantic meaning. For example, a token 204 may be a word “manager,” an abbreviation “mgr.,” a combination “after-hours,” and/or the like. Data units 202 may be processed by SM 134, e.g., one data unit at a time or multiple data units in parallel. SM 134 may determine associations of tokens 204 with anchors 112 of various clusters 111. In some embodiments, clusters 111 may be defined by a developer, e.g., by identifying a semantic meaning associated with a respective cluster. For example, a first cluster may be associated with semantic meaning “supervisor” and may be identified using anchors 112 “supervisor,” “manager,” “shift leader,” and/or the like, a second cluster may be associated with semantic meaning “recruiter” and may be identified with anchors “recruiter,” “hiring manager,” “headhunter,” and/or the like.

Tokens 204 of data unit 202 input into SM 134 may be processed by a token-anchor matching module 220. Token-anchor matching module 220 may compare tokens 204 with anchors 112 of various clusters 111. Each token 204 in data unit 202 that matches an anchor 112 of a particular cluster 111, e.g., a first cluster, may be assigned score 1 (or any other preferred value). The number n₁ of tokens 204 that match anchors 112 of the first cluster may be divided by the total number n of tokens 204 in data unit 202 and the resulting score, S₁=n₁/n, may be assigned to tokens 204 that do not match any of the anchors 112 of the first cluster. Similar matching may be performed for other clusters 111, e.g., second cluster, third cluster, etc., and the corresponding scores S₂, S₃, etc., may be assigned to tokens 204 that do not match the anchors of the corresponding cluster, but are present in data unit 202 together with some of those anchors. As a result, each token 204 may be assigned a respective cluster score S₁, S₂, S₃ . . . that indicates the affinity of the corresponding token to the first cluster, second cluster, third cluster, and so on.

As additional data units 202 are processed by SM 134, a set of cluster scores {Sⱼ} of various tokens may be further modified in view of detected use of the tokens, which may be determined by a token use statistic module 230. More specifically, the second time a given token T is encountered in a new data unit, token T may already have a score Sⱼ that characterizes affinity of token T to jth cluster. The average of jth cluster scores [symbol] Sⱼ [symbol] ᵤₙᵢₜ for all tokens of the new data unit may be computed and used to update the score Sⱼ of token T. In one non-limiting embodiment, the updated score S_{j-updated} may be computed as follows:

$${S}_{j - updated} = \frac{N}{N + 1} {S}_{j} + \frac{1}{N + 1} {〈 {S}_{j} 〉}_{unit '}$$

where N is the number of data units with token T that have been encountered previously. As a result, the more frequently token T is encountered in the same data unit 202 with one of anchors 112 of jth cluster, the higher the score will be. In particular, if token T is always encountered with one of these anchors, score Sⱼ will approach 1 after a large number of such encounters. Conversely, if token T is rarely encountered in the same data unit 202 with one of anchors 112 of jth cluster (or with other tokens that are frequently encountered with such anchors), the corresponding score Sⱼ will tend to 0 (or a small value)

The above example is intended to be illustrative and not limiting. In other embodiments, various other schemes of assigning initial scores to tokens and updating scores of tokens may be used. For example, scores Sⱼ may be limited by a certain maximum value Sₘₐₓ (e.g., Sₘₐₓ=0.5, 0.6, and/or the like). After token score computation module 240 has computed scores of tokens 204 encountered for the first time and/or updated scores of tokens previously encountered (e.g., based on information provided by token use statistics module 230), tokens and token scores may be stored in a token store 210 of data store 110. The stored information for token T may include token T itself, the number of data units in which token T has been encountered, the number of times token T has been encountered together with at least one of the anchors of each cluster, and/or the like. In some embodiments, token store 210 may store additional data related to correlations of use of different tokens, e.g., a number of times token T has been used together with various other tokens T′, T″, etc., that are not anchor tokens.

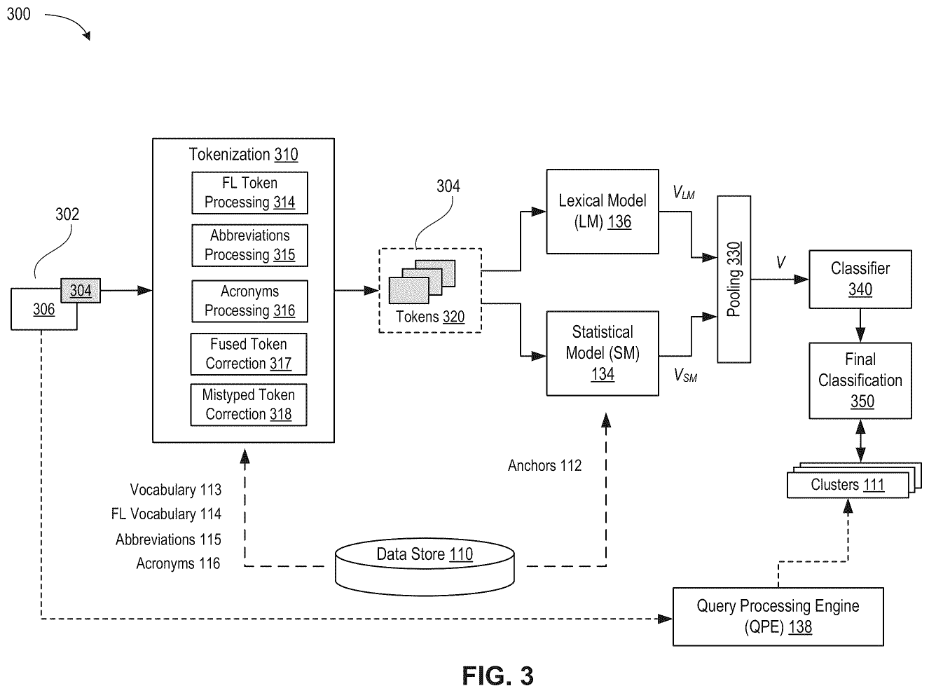

FIG. 3 illustrates an example workflow 300 of deploying machine learning for database standardization, in accordance with one or more embodiments of the present disclosure. Workflow 300 may be performed by QSE 132. Workflow 300 may be used to process a query 302, which may be generated using server machine 130, one of client machines 140 (with reference to FIG. 1), or any other computing device, responsive to a human input and/or automatically. In some instances, query 302 may include a request for information, e.g., any structured request (e.g., by filling a query form) or unstructured (e.g., by using normal human speech) request. In some instances, query 302 may not include any request for information and may instead be an instruction to store (e.g., newly received) information in a database. The term “query,” as used herein, should be understood as including requests generated by any outside entities, e.g., business clients, individual customers, government entities. The term “query” should also be understood as including any internally generated requests, e.g., requests to update an internal database with information received from new clients, new information received from existing clients, information received from public sources, and/or the like. The term “query” should further be understood as including individual (one-time) requests, e.g., requests that are made pursuant to any search for information, including but not limited to requests that are to be executed and returned at runtime. The term “query” should also be understood as including processing of any suitable batches of information, e.g., information collected, processed, indexed, etc., at periodic time intervals, e.g., daily, weekly, monthly, and so on, or responsive to accumulation of any predefined units of arrived information (batches).

Query 302 may include a data unit 304 and any additional associated information 306. In some embodiments, data unit 304 may include information that is processed by machine learning models as part of workflow 300 whereas associated information 306 may be any additional information that is not processed by the models but may be used (e.g., by QPE 138) after the machine learning models have completed processing (e.g., classification) of data unit 304. For example, a data unit 304 may include a title of a document (e.g., “Job descriptions of Company A”) and associated information 306 may include job titles, job descriptions, and/or other information). In another example, associated information 306 may be referenced in data unit 304. For example, data unit 304 may include a request to collect information about email security policy adopted by public universities in a given state and compare the policies with the current policy of the client attached as associated information 306. In some instances, query 302 may include data unit 304 and does not include any associated information 306. For example, data unit 304 may include a request to “find a range of salaries of radiologists in rural areas of New England” with no associated information 306 provided.

Data unit 304 may undergo tokenization 310 that segments data unit 304 into one or more tokens 320. Tokens 320 may refer to any portion of data unit 304 having individual semantic meaning. In the last example, tokens 320 may include four tokens: “salaries” (or “range of salaries”), “radiologists,” “rural areas,” and “New England.” Tokenization 310 may remove filler words, prepositions, conjunctions, punctuation, and/or the like. Tokenization 310 may further include normalization, e.g., reducing plural forms of nouns to singular forms, bringing verbs to a preferred form (e.g., infinitive form), and/or the like.

Tokenization 310 may include foreign language (FL) token processing 314, e.g., translation of tokens from a foreign language (e.g., using FL vocabulary 114) to the primary language of data unit 304. In some embodiments, a web-based translator may be used for FL token processing 314 (e.g., via an appropriate Application Programming Interface available to QSE 132).

Tokenization 310 may further include abbreviation processing 315, which may replace various abbreviations (e.g., “Ovt,” “Mgr,” etc.) with regular words (e.g., “Overtime,” “Manager,” etc.), e.g., using a list of abbreviations 115. Tokenization 310 may also include acronym processing, e.g., replace various acronyms with expanded strings of words (e.g., replace “RN” with “registered nurse”), e.g., using a list of acronyms 116.

Tokenization 310 may also correct irregularly typed/formatted words. More specifically, tokenization 310 may include fused token correction 317, which may be based on vocabulary 113. For example, a string of tokens typed without a space, e.g., “stateagency,” may be changed to the correct string “state agency” and then split into two individual tokens. Tokenization 310 may further perform mistyped token correction 318, e.g., using vocabulary 113. For example, a mistyped token “Utube” may be changed to the correct token “YouTube.”

Tokens 320 may be processed by one or more models, e.g., SM 134 and LM 136. SM 134 may be trained as disclosed above in conjunction with FIG. 2. SM 134 may determine a set of scores {Sⱼ} for each token 320 of data unit 304, where score Sⱼ indicates affinity of the respective token to jth cluster. Scores Sⱼ for different tokens 320 may be aggregated (e.g., added or averaged) to generate an aggregated score ASⱼ=ΣₜₒₖₑₙₛSⱼ. The aggregated scores may then be combined into an embedding vector V_{SM} (or simply, embedding, herein):

V_{SM}=(AS₁, AS₂, . . . AS_{M}),

where M is the total number of classes, and subscript SM indicates that the embedding is generated by SM 134. Each of the M components ASⱼ of the embedding V_{SM} is representative of the likelihood of the data unit 304 belonging to various clusters.

LM 136 may generate an additional embedding V_{LM} that characterizes the same data unit 304. LM 136 may be a natural language processing model. LM 136 may be trained to understand the meaning of tokens, data units, phrases, and/or the like. LM 136 may be or include an N-gram model, a unigram model, a bidirectional model, an exponential model, a neural network-based model, and/or other models, or any combination thereof. In some embodiments, LM 136 may be trained using data units labeled by SM 134 as ground truth. More specifically, a maximum aggregate score

$${max}_{j} {AS}_{j}$$

for training data units may indicate the most likely cluster j. In some embodiments, the training data units may be data units previously processed by SM 134, e.g., as described above. In some embodiments, LM 136 may be initially pre-trained using some general vocabulary and then further trained using data units stored in various DPs 120-1, 120-2 . . . (with reference to FIG. 1). LM 136 may include multiple layers, including but not limited to fully-connected layers and dropout layers, and may generate embeddings for various tokens of input data units. In some embodiments, embedding generated by LM 136 may also have M components (where M is the number of clusters),

V_{LM}=(LM₁, LM₂, . . . LM_{M}),

each component LMⱼ being representative of the likelihood of the data unit 304 belonging to a corresponding cluster j.

Predictions of SM 134 and LM 136 may be aggregated (pooled) by a pooling classifier 330. In some embodiments, embeddings V_{LM} and V_{SM} may be aggregated using maximum pooling, where components of the pooled (aggregated) embedding V=(V₁, V₂, . . . . V_{M}) are determined by the maximum values of the two components,

Vⱼ=max (SMⱼ, LMⱼ).

In some embodiments, the components of the pooled embedding V may be determined as the average values of the two components,

$${V}_{j} = \frac{S {M}_{j} + L {M}_{j}}{2} .$$

In some embodiments, the components of the pooled embedding V may be determined as the weighted average values of the two components,

$${V}_{j} = \frac{w \cdot {SM}_{j} + ( 1 - w ) \cdot {LM}_{j}}{2} ,$$

with weight w (e.g., defined in the range 0≤w≤1) determining a relative importance (trust) given to predictions SM 134 and LM 136; with weight w=½ indicating equal importance given to outputs of both models, weights w that are close to 0 indicating greater importance given to outputs of LM 136, and weights w that are close to 1 indicating greater importance given to outputs of SM 134.

Pooled embedding V=(V₁, V₂, . . . . V_{M}) may be used as an input into classifier 340 that determines probabilities Pⱼ that data unit 304 is associated with cluster j. In one illustrative non-limiting example, the probabilities may be computed using the softmax function,

$${P}_{j} = \frac{exp ( α {V}_{j} )}{{Σ}_{i} exp ( α {V}_{i} )} ,$$

with α being an empirically determined parameter. In some embodiments, α=1. Computed probabilities Pⱼ may be used for final classification 350. Final classification 350 may include selecting a cluster, e.g., cluster k, associated with the highest probability Pₖ of the set of probabilities {Pⱼ}. Once the maximum-probability cluster k has been identified, QPE 138 may use the identified cluster for retrieving data associated with that cluster. For example, final classification 350 of data unit 304 requesting information for “double pay” of employees of electric power stations may be associated with cluster “Overtime Pay.” Correspondingly, QPE 138 may retrieve all relevant data related to “overtime pay” category, e.g., using any suitable database search techniques.

In some implementations, final classification 350 may also include determining (and storing/outputting) a confidence level for the prediction. The confidence level may be determined by numerical value of the maximum probability Pₖ. In one illustrative example, the maximum probability Pₖ>0.8 may indicate a very high confidence level, the maximum probability in the range 0.6<Pₖ≤0.8 may indicate a high confidence level, the maximum probability in the range 0.4<Pₖ≤0.6 may indicate a medium confidence level, and the maximum probability in the range 0.2<Pₖ≤0.4 may indicate a low confidence level. It should be noted that these numbers are intended as an illustration only and that the thresholds separating various confidence levels may be set differently in various embodiments.

In some embodiments, confidence level may be determined in view of separate predictions made based on individual components of embeddings V_{SM} and V_{LM} output by the two models separately. For example, separate sets of probabilities {P_{j-SM}} and {P_{j-LM}} may be computed based on respective embeddings V_{SM} and V_{LM}, e.g., using a softmax classifier as described above or any other suitable classifier. In one example embodiment, a prediction may be determined to have a high confidence level provided that independent predictions of SM 134 and LM 136 coincide (the highest probabilities P_{k-SM} and P_{k-LM} correspond to the same cluster k) and the aggregated probability Pₖ is above a first empirically set threshold P₁, e.g., P₁=0.2, 0.3, 0.4, and/or the like. A prediction may also be determined to have a high confidence level if predictions of SM 134 and LM 136 do not coincide, but the higher prediction is above a second empirically set threshold P₂. In some embodiments, P₂>P₁. If none of the above two scenarios is realized, the prediction may be determined to have a low confidence level.

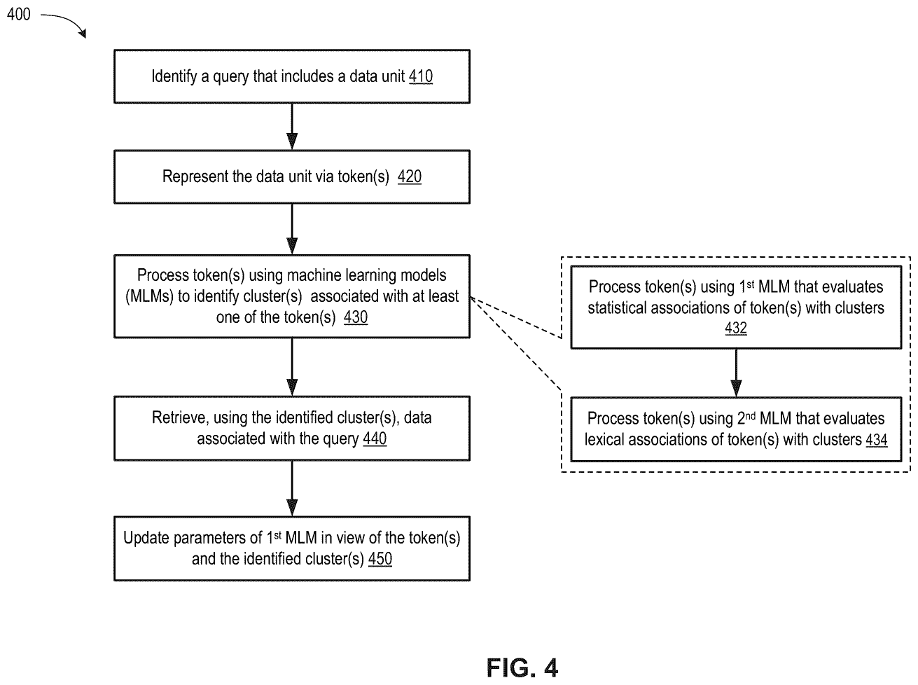

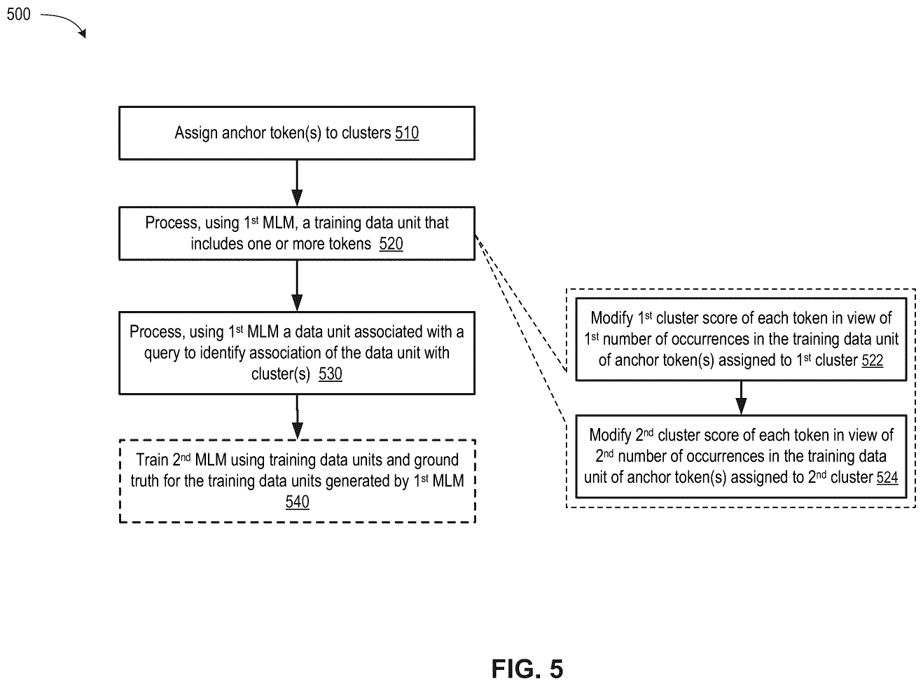

FIGS. 4-5 illustrate example methods 400 and 500 that can be used for efficient standardization of stored information and processing of queries. A processing device, having one or more processing units (CPUs) and memory devices communicatively coupled to the CPU(s), may perform method 400 and/or method 500 and/or each of their individual functions, routines, subroutines, or operations. The processing device executing method 400 and/or method 500 may be a processing device of server machine 130 and/or client machine(s) 140 of FIG. 1. In certain implementations, a single processing thread may perform method 400 and/or method 500. Alternatively, two or more processing threads may perform method 400 and/or method 500, each thread executing one or more individual functions, routines, subroutines, or operations of the methods. In an illustrative example, the processing threads implementing method 400 and/or method 500 may be synchronized (e.g., using semaphores, critical sections, and/or other thread synchronization mechanisms). Alternatively, the processing threads implementing method 400 and/or method 500 may be executed asynchronously with respect to each other. Various operations of method 400 and/or method 500 may be performed in a different order compared with the order shown in FIG. 4 and/or FIG. 5. Some operations of method 400 and/or method 500 may be performed concurrently with other operations. Some operations may be optional.

FIG. 4 is a flow diagram illustrating an example method 400 of deploying machine learning for data standardization, in accordance with one or more embodiments of the present disclosure. At block 410, method 400 may include identifying, by a processing device, a query that includes a data unit (e.g., query 302 and data unit 304, as depicted in FIG. 3). At block 420, method 400 may continue with representing, by the processing device, the data unit via one or more tokens (e.g., by performing tokenization 310 to obtain tokens 320). In some embodiments, representing the data unit via one or more tokens may include performing at least one of the following: correcting spelling of one or more words in the data unit, translating one or more foreign-language words in the data unit, replacing one or more acronyms in the data unit, expanding one or more abbreviations in the data unit, adding one or more spaces between two or more words in the data unit.

At block 430, method 400 may include processing, by the processing device, the one or more tokens using a plurality of machine learning models (MLMs) to identify one or more clusters of a plurality of clusters. Each of the one or more identified clusters may be associated with at least one token of the one or more tokens of the data unit. In some embodiments, individual clusters of the plurality of clusters may be predefined by associating one or more anchor tokens (e.g., anchors 112 in FIG. 3) with a respective cluster. In some embodiments, different clusters may be associated with different lexical units having the same or substantially the same semantic meaning.

As illustrated with the callout portion of FIG. 4, processing the one or more tokens as part of block 430 may include multiple operations. More specifically, at block 432, processing the one or more tokens may include using a first MLM (e.g., statistical model 134) of the plurality of MLMs. The first MLM may evaluate statistical associations of the one or more tokens with the plurality of clusters. In some embodiments, the statistical associations may be quantified by scores Sⱼ assigned to various tokens of the data unit for different clusters j. In some embodiments, the statistical associations of the one or more tokens with a given cluster may characterize a number of times the one or more tokens have been encountered in training data units together with the one or more anchor tokens associated with the given cluster. A dependence of the scores Sⱼ on the number of times need not be linear. In some embodiments, the training data units may include data units previously processed by the first MLM (e.g., actual queries generated by one or more clients).

At block 434, processing the one or more tokens may include using a second MLM (e.g., lexical model 136) of the plurality of MLMs. The second MLM may evaluate lexical associations of the one or more tokens with the plurality of clusters. In some embodiments, the second model may be trained (at least partially) using a plurality of training data units and ground truth labels generated by application of the first model to the plurality of training data units.

At block 440, method 400 may include retrieving, using the one or more identified clusters, data associated with the query. For example, having determined a semantic meaning of various tokens in the data unit, QPE 138 may identify and retrieve pertinent data stored in various data stores accessible to the processing device performing method 400.

In some embodiments, method 400 may further include updating one or more parameters of the first MLM in view of the one or more tokens and the one or more identified clusters. More specifically, the newly encountered tokens of the data unit may be used to further modify scores of the tokens based on the determined associations with the identified clusters, e.g., as described in conjunction with FIG. 3 or in some similar way.

FIG. 5 is a flow diagram illustrating an example method 500 of training one or more models that may be used for database standardization, in accordance with one or more embodiments of the present disclosure. A model trained in accordance with method 500 may include the first MLM (e.g., statistical model 134) of method 400. At block 510, method 500 may include assigning one or more anchor tokens (e.g., anchors 112 in FIG. 2) to each cluster of a plurality of clusters (e.g., clusters 111).

At block 520, method 500 may continue with processing, using a first MLM, a training data unit that includes one or more tokens (e.g., tokens 204 in FIG. 2). As illustrated with the callout portion of FIG. 5, processing the training data unit may include, at block 522, modifying a first cluster score (e.g., S₁) of each token of the one or more tokens in view of a first number of occurrences in the training data unit of the one or more anchor tokens assigned to a first cluster of the plurality of clusters. In some embodiments, prior to processing the training data unit, the first cluster score may characterize a number of times a respective token of the one or more tokens has been encountered in previous training data units together with the one or more anchor tokens assigned to the first cluster. After the training data unit is processed, the first cluster score may be modified (e.g., provided that the training data unit includes one or more anchors of the first cluster). In some embodiments, a higher (lower) first cluster score (e.g., S₁) of a given token may indicate a higher (lower) probability of occurrence, in the same data unit, of the given token with the one or more anchor tokens of the first cluster. At block 524, processing the training data unit may further include modifying a second (third, etc.) cluster score (e.g., S₂, S₃, etc.) of each token of the one or more tokens in view of a second (third, etc.) number of occurrences in the training data unit of the one or more anchor tokens assigned to a second (third, etc.) cluster of the plurality of clusters.

At block 530, method 500 may include training a second MLM (e.g., lexical model 136) of the one or more MLMs using a plurality of training data units and ground truth labels generated by application of the first MLM to the plurality of training data units. In some embodiments, the training data units used for training of the second MLM may include at least some training data units that were used for training of the first MLM. In some embodiments, at least some of the training data units used for training of the second MLM may be different from the training data units that were used for training of the first MLM. In some embodiments, the second MLM may be an embeddings language model, e.g., nnlm-en-dim 128 model (or a similar model), that was pre-trained using English Google News 200B corpus (or a similar vocabulary).

FIG. 6 depicts an example computer system 600 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 618, which communicate with each other via a bus 630.

Processing device 602 (which can include processing logic 603) represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 622 for implementing query standardization engine 132 and/or training query processing engine 138 of FIG. 1 and to perform the operations discussed herein (e.g., methods 400-500 of FIGS. 4-5).

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker). In one illustrative example, the video display unit 610, the alphanumeric input device 612, and the cursor control device 614 may be combined into a single component or device (e.g., an LCD touch screen).

The data storage device 618 may include a computer-readable storage medium 624 on which is stored the instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable media. In some implementations, the instructions 622 may further be transmitted or received over a network 620 via the network interface device 608.

While the computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
identifying, by a processing device, a query comprising a data unit;
representing, by the processing device, the data unit via one or more tokens;
processing, by the processing device, the one or more tokens using a plurality of machine learning models (MLMs) to identify one or more clusters of a plurality of clusters, wherein each of the one or more identified clusters is associated with at least one token of the one or more tokens, wherein processing the one or more tokens comprises:
processing the one or more tokens using a first MLM of the plurality of MLMs to generate a first embedding vector comprising a first plurality of components, wherein an individual component of the first plurality of components characterizes a likelihood of a historical association of the one or more tokens with a respective cluster of the plurality of clusters;
processing the one or more tokens using a second MLM of the plurality of MLMs to generate a second embedding vector comprising a second plurality of components, wherein an individual component of the second plurality of components characterizes a likelihood of a lexical association of the one or more tokens with a respective cluster of the plurality of clusters; and
identifying the one or more clusters using a third embedding, aggregated from the first embedding and the second embedding; and
retrieving, using the one or more identified clusters, data associated with the query.

2. The method of claim 1, wherein individual clusters of the plurality of clusters are initialized by associating one or more anchor tokens with a respective cluster.

3. The method of claim 2, wherein the historical association of the one or more tokens with the respective cluster of the plurality of clusters characterizes a number of times the one or more tokens have been encountered in training data units together with the one or more anchor tokens associated with the respective cluster.

4. The method of claim 3, wherein the training data units comprise data units previously processed by the first MLM.

5. The method of claim 3, further comprising:
updating one or more parameters of the first MLM in view of the one or more tokens and the one or more identified clusters.

6. The method of claim 1, wherein each cluster of at least a subset of the plurality of clusters is associated with different lexical units having a substantially same semantic meaning.

7. The method of claim 1, wherein the second MLM is trained using:
a plurality of training data units, and
ground truth labels generated by application of the first MLM to the plurality of training data units.

8. The method of claim 1, wherein representing the data unit via one or more tokens comprises performing at least one of:
correcting spelling of one or more words in the data unit, translating one or more foreign-language words in the data unit, replacing one or more acronyms in the data unit,
expanding one or more abbreviations in the data unit, or
adding one or more spaces between two or more words in the data unit.

9. A method comprising:
initiating a plurality of clusters by assigning one or more anchor tokens to each cluster of the plurality of clusters; and
training a first MLM using a training data unit comprising one or more tokens, wherein training the first MLM comprises:
causing the first MLM to access a first cluster score of each token of the one or more tokens;
causing the first MLM to modify the first cluster score of each token of the one or more tokens in view of a first number of occurrences, in the training data unit, of the one or more anchor tokens assigned to a first cluster of the plurality of clusters;
receiving a query comprising one or more query tokens;
causing the first MLM to generate, using the first cluster scores of each of the one or more query tokens, an embedding vector comprising a plurality of components, wherein an individual component of the plurality of components characterizes a likelihood of a historical association of the one or more query tokens with the first cluster; and
processing, using a machine learning classifier, the embedding vector to retrieve data associated with the query.

10. The method of claim 9, wherein training the first MLM further comprises:
causing the first MLM to access a second cluster score of each token of the one or more tokens; and
causing the first MLM to modify the second cluster score of each token of the one or more tokens in view of a second number of occurrences in the training data unit of the one or more anchor tokens assigned to a second cluster of the plurality of clusters.

11. The method of claim 9, wherein each cluster of at least a subset of the plurality of clusters is associated with different lexical units having a substantially same semantic meaning.

12. The method of claim 9, wherein, prior to training the first MLM using the training data unit, the first cluster score characterizes a number of times a respective token of the one or more tokens has been encountered in previous training data units together with the one or more anchor tokens assigned to the first cluster.

13. The method of claim 9, wherein a higher first cluster score indicates a higher probability of occurrence, in a same data unit, of a respective token of the one or more tokens with the one or more anchor tokens assigned to the first cluster.

14. The method of claim 9, further comprising:
processing, using the trained first MLM, a data unit associated with a query, to identify association of the data unit with one or more clusters of the plurality of clusters.

15. The method of claim 9, further comprising:
training a second MLM of the one or more MLMs using a plurality of training data units and ground truth labels generated by application of the first MLM to the plurality of training data units, wherein the second MLM is a pre-trained embeddings language model.

16. A system comprising:
a memory; and
a processing device coupled to the memory, the processing device to perform operations comprising:
identifying, by a processing device, a query comprising a data unit;
representing, by the processing device, the data unit via one or more tokens;
processing, by the processing device, the one or more tokens using a plurality of machine learning models (MLMs) to identify one or more clusters of a plurality of clusters, wherein each of the one or more identified clusters is associated with at least one token of the one or more tokens, wherein processing the one or more tokens comprises:
processing the one or more tokens using a first MLM of the plurality of MLMs to generate a first embedding vector comprising a first plurality of components, wherein an individual component of the first plurality of components characterizes a likelihood of a historical association of the one or more tokens with a respective cluster of the plurality of clusters;
processing the one or more tokens using a second MLM of the plurality of MLMs to generate a second embedding vector comprising a second plurality of components, wherein an individual component of the second plurality of components characterizes a likelihood of a lexical association of the one or more tokens with a respective cluster of the plurality of clusters; and
identifying the one or more clusters using a third embedding, aggregated from the first embedding and the second embedding; and
retrieving, using the one or more identified clusters, data associated with the query.

17. The system of claim 16, wherein individual clusters of the plurality of clusters are initialized by associating one or more anchor tokens with a respective cluster.

18. The system of claim 17, historical association of the one or more tokens with the respective cluster of the plurality of clusters characterizes a number of times the one or more tokens have been encountered in training data units together with the one or more anchor tokens associated with the respective cluster.

19. The system of claim 16, wherein each cluster of at least a subset of the plurality of clusters is associated with different lexical units having a substantially same semantic meaning.

20. The system of claim 16, wherein representing the data unit via one or more tokens comprises performing at least one of:
correcting spelling of one or more words in the data unit, translating one or more foreign-language words in the data unit, replacing one or more acronyms in the data unit,
expanding one or more abbreviations in the data unit, or
adding one or more spaces between two or more words in the data unit.
